(19) United States
(12) Patent Application Publication
(10) Pub. No.: US 2007/0060166 A1
(43) Pub. Date: Mar. 15, 2007

(54) Traffic detection system and communication-quality monitoring system on a network

(75) Inventors: Tsutomu Kitamura, Tokyo (JP); Toshiya Okabe, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/489,603

(22) Filed: Jul. 20, 2006

(30) Foreign Application Priority Data
Jul. 21, 2005 (JP) 2005-211627

(51) Int. Cl. H04Q 7/20

(52) U.S. Cl. 455/450

(57) ABSTRACT

A communication-quality monitoring system includes a receiving unit for receiving packets to detect packets of a traffic, a frequency-distribution calculator for calculating frequency distribution of the arrival times of the received packets, and a degradation detection unit for detecting degradation of communication quality in the network by comparing statistic parameters of the peak in the frequency distribution against thresholds of the parameters. The parameters include a dispersion, standard deviation, half-power breadth and peak power of the peak in the distribution diagram.

### BACKGROUND OF THE INVENTION

(a) Field of the Invention

The present invention relates to a traffic detection system on a network and, more particularly, to a technique for detecting a subject traffic flowing on a network. The present invention also relates to a communication-quality monitoring system.

(b) Description of the Related Art

Recently, a specific communication service attracts a higher attention, which allows transmission/reception of a voice communication via the IP network while packetizing voice data by using a voice application program such as voice over internet protocol (VoIP). This communication service is now remarkably growing in the form of the “internet telephone”. It is known however that the internet telephone suffers from degradation in the communication quality such as a delay or disappearance of the packets within the IP network.

Patent Publications JP-2002-232475 and -2004-165818 describe a technique for monitoring the communication quality of the voice communication in the internet telephone. In the technique of these publications, the traffic on the network is subjected to a protocol analysis for each of the packets in order to calculate the throughput, jitter and packet loss factor of the voice traffic.

Patent Publication JP-2005-57331 describes a technique for evaluating the voice quality of a VoIP gateway. In this technique, the VoIP packets arriving at the port of a network interface are examined in the voice quality thereof by collecting and analyzing the statistical information as to degradation factors of the voice quality including delay, jitter, loss and wrong order of the VoIP packets.

In a wireless local area network (WLAN) such as prescribed in IEEE 802.11, an encryption protocol, e.g., wired equivalent privacy (WEP) is used to encrypt the communication data in the data link layer, to thereby prevent illegal interception or monitoring of the WLAN data by a third party. In the standard of the encryption scheme for the WLAN, issued by Wi-Fi protected access (WPA), an encryption protocol referred to as temporal key integrity protocol (TKIP), which allows the encryption key to be automatically updated at a specified time interval, is employed for eliminating vulnerability of the WEP in statically using a single key.

In the current tendency, a variety of communication systems have shifted to use the IP technique, and at the same time, the demand for a safe communication has increased the interest for the security countermeasures using the encrypted communication. Thus, a security architecture for the internet protocol (IPsec) is prescribed by the internet engineering task force (IETF) in order for encrypting all the IP communications in the IP layer without depending on the application program to thereby secure the safe communication for each host. The IPsec is intensively used for configuring a virtual private network (VPN) using the internet.

It is noted here that the technique described in Patent Publications JP-2002-232475 and -2004-165818 uses a protocol analysis for each of the packets in order for evaluating the communication quality. In the WLAN communication system however, the WLAN data transferred through a communication path using the TKIP as the encryption protocol cannot be decrypted to thereby preclude the protocol analysis, because the encryption key is dynamically updated. That is, WLAN communication system does not allow the voice traffic to be detected from the encrypted WLAN traffic, and thus the monitoring of the voice quality by using the described technique is impossible. This problem is common to encrypted communication paths using the IPsec as the encryption protocol.

In the technique described in Patent Publication JP-2005-57331, the voice quality is examined based on the statistical information of the VoIP packets. In this case, if the traffic includes packets other than the VoIP packets, the subject VoIP packets must be separated from the other packets before creating the statistical information. However, since the packet analysis is impossible with respect to the encrypted packets, as described above, the VoIP packets cannot be separated from the other packets, whereby it is impossible to monitor the voice quality in the WLAN traffic or the traffic of the communication path encrypted using the encryption protocol.

### SUMMARY OF THE INVENTION

In view of the above problems in the conventional techniques, it is an object of the present invention to provide a traffic detection system which is capable of detecting a subject traffic from encrypted traffics flowing on a network without decrypting the encrypted traffic.

It is another object of the present invention to provide a communication-quality monitoring system which is capable of detecting a subject traffic from encrypted traffics flowing on a network without decrypting the encrypted traffic and monitoring the communication quality of the subject traffic component.

It is a further object of the present invention to provide a method and a program used in the traffic detection system and the communication-quality monitoring system.

The present invention provides, in a first aspect thereof, a traffic detection system including: a receiving unit for receiving packets configuring a traffic on a network; frequency-distribution calculation unit for calculating a frequency distribution of arrival times of the received packets based on arrival times of the received packets; and a traffic detection unit for comparing data of the frequency distribution calculated by the frequency-distribution calculation unit against data of an expected frequency distribution of arrival times of a subject traffic to be detected, to detect the subject traffic based on the comparison.

The present invention also provides, in a second aspect thereof, a traffic detection method including the steps of: receiving packets configuring a traffic on a network; calculating a frequency distribution of arrival times of the received packets based on arrival times of the received packets; and comparing data of the frequency distribution calculated by the frequency-distribution calculating step against data of an expected frequency distribution of arrival times of a subject traffic to be detected, to detect the subject traffic based on the comparison.

In accordance with the first and second aspects of the present invention, detection of the subject application can be achieved by calculating the frequency distribution of the packets and comparing data of the calculated frequency distribution and data of the expected frequency distribution of the subject traffic, without using packet analysis as used in the conventional technique, whereby the subject traffic can be also detected from encrypted traffics.

The present invention also provides, in a third aspect thereof, a communication-quality monitoring system including: a receiving unit for receiving packets configuring a traffic on a network; frequency-distribution calculation unit for calculating a frequency distribution of arrival times of the received packets based on arrival times of the received packets; and a communication quality judgement unit for comparing at lest one parameter of said frequency distribution against a threshold stored in a communication-quality-threshold memory to judge presence or absence of a degradation in a communication quality of the traffic on the network based on the comparison.

The present invention provides, in a fourth aspect thereof, a communication quality monitoring method including the steps of: receiving packets configuring a traffic on a network; calculating a frequency distribution of arrival times of the received packets based on arrival times of the received packets; calculating at least one parameter from the frequency distribution; and comparing the calculated parameter calculated by the parameter calculating step against a threshold stored in a communication-quality-threshold memory to judge presence or absence of a degradation in a communication quality of the traffic on the network based on the comparison.

The present invention provides, in a fifth aspect thereof, a communication-quality monitoring system including: a receiving unit for receiving packets configuring a traffic on a network; frequency-distribution calculation unit for calculating a frequency distribution of arrival times of the received packets based on arrival times of the received packets; a traffic detection unit for comparing data of the frequency distribution calculated by the frequency-distribution calculation unit against data of an expected frequency distribution of arrival times of a subject traffic to be detected, to detect the subject traffic based on the comparison; and a communication quality judgement unit for comparing at least one parameter of said frequency distribution against a threshold stored in a communication-quality-threshold memory to judge presence or absence of a degradation in a communication quality of the traffic on the network based on the comparison.

The present invention provides, in a sixth aspect thereof, a communication quality monitoring method including the steps of: receiving packets configuring a traffic on a network; calculating a frequency distribution of arrival times of the received packets based on arrival times of the received packets; comparing data of the frequency distribution calculated by the frequency-distribution calculation unit against data of an expected frequency distribution of arrival times of a subject traffic to be detected, to detect the subject traffic based on the comparison, calculating at least one parameter from the frequency distribution for the detected subject traffic; and comparing the calculated parameter against a threshold stored in a communication-quality-threshold memory to judge presence or absence of a degradation in a communication quality of the traffic on the network based on the comparison.

In accordance with the third through sixth aspects of the present invention, a degradation of the communication quality can be detected by using the parameter of the frequency distribution of arrival times of the packets, whereby the degradation can be detected without analyzing the contents of the packets.

The present invention provides, in a seventh aspect thereof, a program running on a computer to operate the computer in the processings of: receiving packets configuring a traffic on a network; calculating a frequency distribution of arrival times of the received packets based on arrival times of the received packets; and comparing data of the frequency distribution calculated by the frequency-distribution calculation unit against data of an expected frequency distribution of arrival times of a subject traffic to be detected, to detect the subject traffic based on the comparison.

The present invention provides, in an eighth aspect thereof a program running on a computer to operate the computer in the processings of: receiving packets configuring a traffic on a network; calculating a frequency distribution of arrival times of the received packets based on arrival times of the received packets; calculating at least one parameter from the frequency distribution; and comparing the calculated parameter calculated by the parameter calculating processing against a threshold stored in a communication-quality-threshold memory to judge presence or absence of a degradation in a communication quality of the traffic on the network based on the comparison.

The present invention provides, in a ninth aspect thereof, a program running on a computer to operate the computer in the processings of: receiving packets configuring a traffic on a network; calculating a frequency distribution of arrival times of the received packets based on arrival times of the received packets; comparing data of the frequency distribution calculated by the frequency-distribution calculation unit against data of an expected frequency distribution of arrival times of a subject traffic to be detected, to detect the subject traffic based on the comparison, calculating at least one parameter from the frequency distribution for the detected subject traffic; and comparing the calculated parameter calculated by the parameter calculating processing against a threshold stored in a communication-quality-threshold memory to judge presence or absence of a degradation in a communication quality of the traffic on the network based on the comparison.

The above and other objects, features and advantages of the present invention will be more apparent from the following description, referring to the accompanying drawings.

### BRIEF DESCRIPTION OF THE DRAWINGS

FIG. 1 is a block diagram of a communication system including a communication-quality monitoring system according to a first embodiment of the present invention.

FIG. 2 is a table tabulating the expected frame lengths stored in the expected-frame-length memory shown in FIG. 1.

FIG. 3 is a graph showing a practical example of the arrival-time distribution diagram of the packets generated by a voice application program, Netmeeting Voice, plotted with respect to the frequency.

FIG. 4 is a graph showing a practical example of the arrival-time distribution diagram for the packets generated by another voice application, SIP softphone, plotted with respect to the frequency.

FIG. 5 is a graph showing a practical example of the arrival-time distribution diagram for the packets generated by a non-voice application, Netmeeting Video, plotted with respect to the frequency.

FIG. 6 is a table tabulating practical values of the expected arrival-time distribution diagram stored in the expected distribution-data memory shown in FIG. 1.

FIG. 7 is a table tabulating practical values of the threshold used for judging the communication quality and stored in the quality threshold memory shown in FIG. 1.

FIG. 8 is a flowchart of the procedure in the communication-quality monitoring system of FIG. 1.

FIG. 9 is a block diagram of the communication-quality monitoring system, additionally showing the flow of traffic.

FIG. 10 is a timing chart showing the calculation of the arrival-time/frequency distribution diagram.

FIG. 11 is block diagram of a communication system including a communication-quality monitoring system according to a second embodiment of the present invention.

### PREFERRED EMBODIMENT OF THE INVENTION

Now, the present invention is more specifically described with reference to accompanying drawings, wherein similar constituent elements are designated by similar reference numerals.

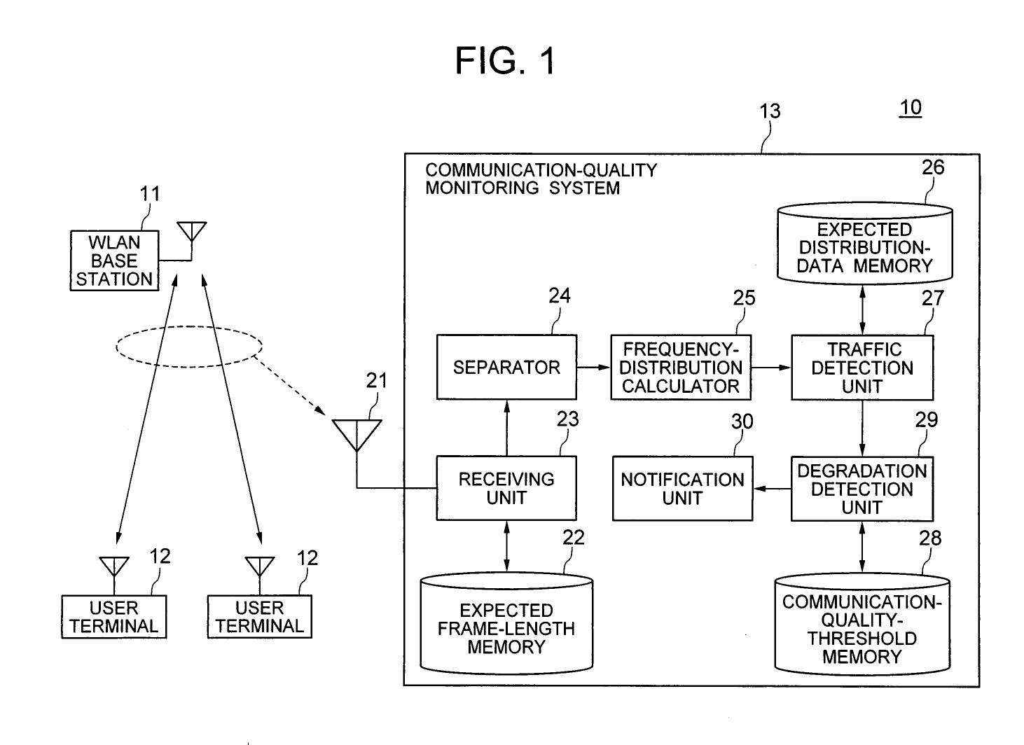

FIG. 1 shows a communication system including a communication-quality monitoring system according to a first embodiment of the present invention. The communication system, generally designated by numeral 10, includes a plurality of WLAN base stations 11, a plurality of user terminals 12 for use in a cellular phone system, and a communication-quality monitoring system 13. The WLAN base stations 11 establish a communication with the user terminals 12 by using an encrypted wireless communication. The user terminals 12 may be personal computers, for example, on which a variety of programs run including voice application programs, such as an IP telephone program. Thus, the traffics between the WLAN base stations 11 and the user terminals 12 include voice traffics generated by the voice application programs.

The communication-quality monitoring system 13 receives communications exchanged between the WLAN base stations 11 and the user terminals 12, to evaluate the communication quality of the voice communications. The communications between the WLAN base stations 11 and the user terminals 12 are encrypted communications, for which the technique of packet analysis cannot be used for detecting the voice traffics and evaluating the communication quality. It is noticed here that the voice application program executes transmission/reception of the voice traffics at a specific fixed time interval. In view of this, in the present embodiment, the communication-quality monitoring system 13 calculates the frequency distribution of the arrival time of the packets in order to detect a voice traffic from the traffic on the network. The voice traffic generally has a substantially fixed frequency component of arrival times due to the fixed time interval of packet transmission. The voice traffic detected based on the frequency distribution of the arrival times of the packets is then subjected to evaluation of the communication quality of the network.

The communication-quality monitoring system 13 includes an antenna 21, an expected frame-length memory 22, a receiving unit 23, a separator 24, an arrival-time/frequency-distribution calculator (frequency-distribution calculator) 25, an expected distribution-data memory 26, a traffic detection unit 27, a communication-quality-threshold memory 28, and a degradation judgement unit 29. The communication-quality monitoring system 13 is configured by a computer system such as a workstation, on which a variety of programs run to realize desired functions.

The receiving unit 23 receives via the antenna 21 traffics exchanged between the WLAN base stations 11 and the user terminals 12. The expected frame-length memory 22 stores therein a list of expected frame lengths for the packets configuring the subject traffics, or voice traffics, to be detected. The expected frame lengths are determined based on codecs used in the voice application program and the packet transmission interval thereof, or based on the frame lengths measured beforehand in the communication system. The receiving unit 23 transfers, to the separator 24, specific packets selected among the received packets and having a possibility that the packets are voice packets generated using the voice application program.

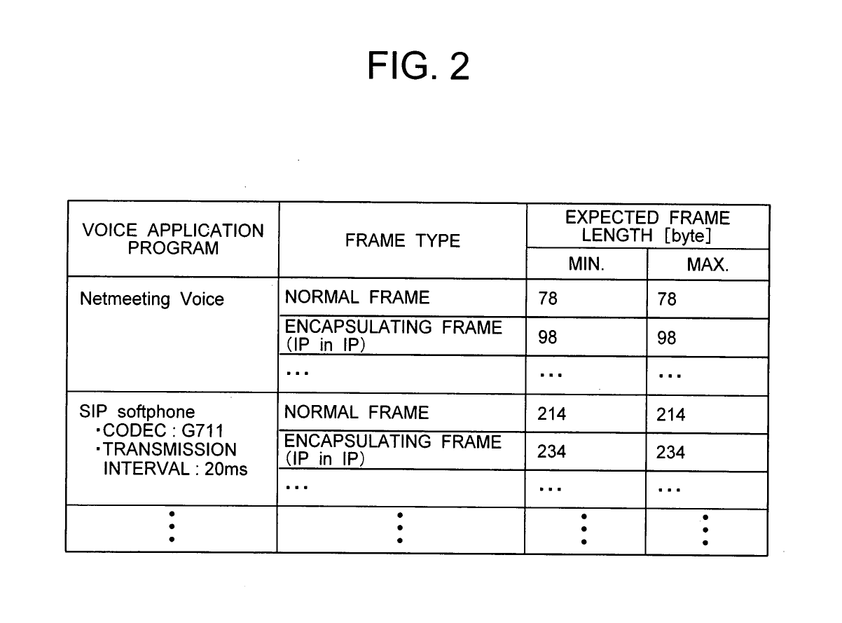

FIG. 2 shows a practical example of the list of expected frame lengths stored in the expected frame-length memory 22. In general, the packets configuring the traffic generated by a voice application program have a specific characteristic in that the resultant packets have a fixed frame length depending on the application program used for generating the packets. The expected frame-length memory 22 thus stores therein expected frame lengths each including the maximum and minimum thereof for each of the voice application programs including “Netmeeting Voice”, “SIP softphone” etc. If the voice application program has a plurality of frame modes for the resultant traffic, such as a normal frame and an encapsulating frame IP-in-IP, the frame length of each of the fame modes is stored in the expected frame-length memory 22. The receiving unit 23 detects the packets having a frame length between the maximum and the minimum of the expected frame lengths stored in the expected frame-length memory 22, and transfers the detected packets to the separator 24.

The separator 24 classifies and separates the packets transferred from the receiving unit 23 into a plurality of packet groups each specifying a common transmission terminal and a common destination terminal and thus configuring a single traffic. The separator 24 may additionally separate the packets into a plurality of sub-groups each including a common frame length. The frequency-distribution calculator 25 receives the packet groups from the separator 24 and calculates data of an arrival-time/frequency distribution diagram (frequency distribution diagram) for each of the packet groups based on the information of the arrival time of the packets in the each of the packet groups as by using the Fourie transformation.

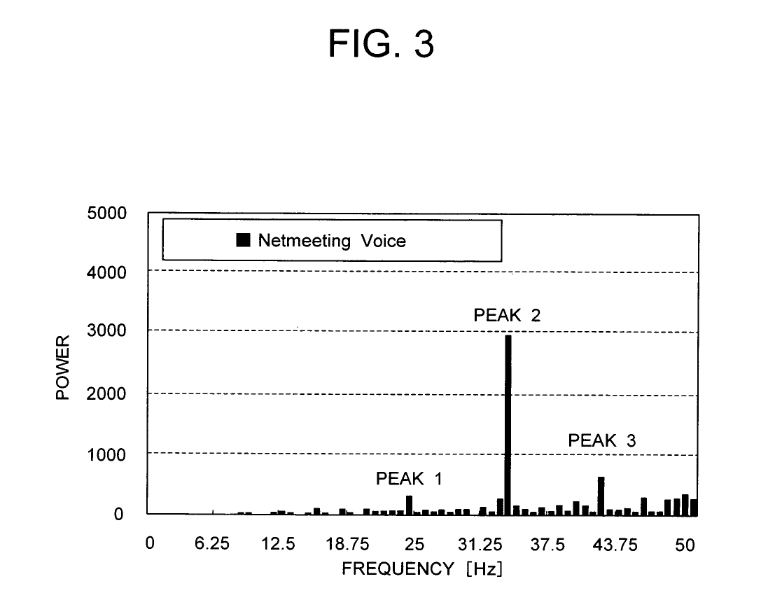

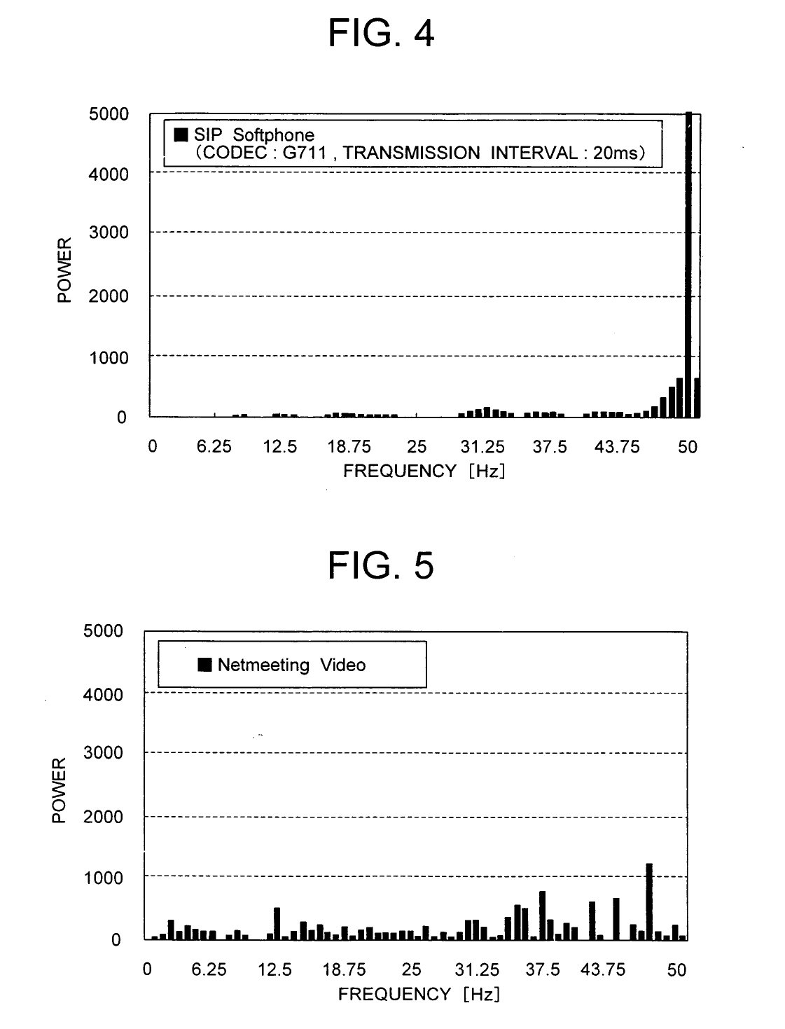

FIGS. 3 and 4 each show a practical example of the frequency distribution diagram of the packets configuring a traffic generated by a voice application program. In general, since a voice application program transmits/receives packets at a fixed time interval, as described before, the frequency of the arrival times of the packets for the voice application program is constant and may be calculated by reciprocal of the specific time interval. The frequency distribution of the arrival times is obtained by Fourie transform of the bit stream of the packets, and has a peak at a specific frequency such as shown in FIGS. 3 and 4.

For example, Netmeeting Voice provides a peak power at a frequency of 33 Hz as shown in FIG. 3 because Netmeeting Voice transmits packets at a time interval of 30 milliseconds (ms), whereas SIP softphone provides a peak power at a frequency of 50 Hz as shown in FIG. 5 because SIP softphone transmits packets at a time interval of 20 ms. On the other hand, a moving-picture application program such as Netmeeting Video does not provide a significant peak power differently from the voice application programs, because the moving-picture application program does not transmit the packets at a fixed time interval. That is, as shown in FIG. 5, a significant peak power is not observed in the frequency distribution diagram for the packets of a traffic generated by the moving-picture application program.

The expected distribution-data memory 26 stores therein a list of data of the expected frequency distribution diagram. The data of the expected frequency distribution diagram include an expected peak frequency range within which a strong peak or steep peak of the distribution diagram is expected to appear, and a peak power range that the strong peak of the frequency distribution diagram has. The data of the expected frequency distribution diagram may be calculated from the transmission interval of the voice application program, or determined based on the data obtained by actual measurements. The traffic detection unit 27 detects a peak or peaks of the frequency distribution diagram by using a known algorithm such as a smoothing differential calculus from the frequency distribution of the packets calculated by the frequency-distribution calculator25. The traffic detection unit 27 then calculates the peak frequency and the peak power for the detected peak, and compares the parameters of the peak frequency and peak power of each peak against the data of expected distribution diagrams (expected distribution data) stored in the expected distribution-data memory 26 to detect a voice traffic.

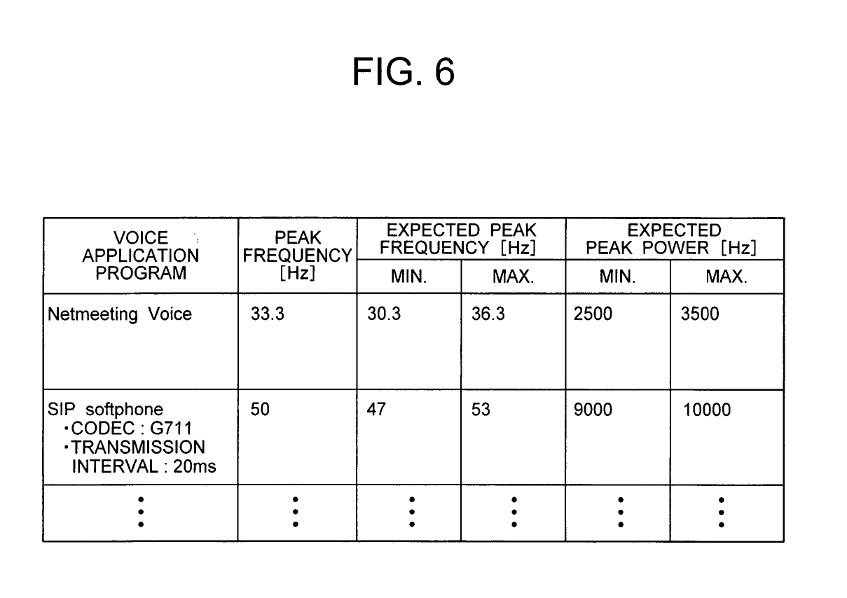

FIG. 6 is a table showing an example of the expected distribution data stored in the expected distribution-data memory 26. In the list, the theoretical peak frequency, an expected peak frequency range including the minimum and maximum thereof, and an expected peak power range including the minimum and maximum thereof are tabulated for each of the voice application programs used in the user terminals 12. The peak frequency as used herein means the frequency at which the peak power is observed in the frequency distribution diagram.

The traffic detection unit 27 examines whether or not the peak detected from the frequency distribution calculated by the frequency-distribution calculator 25 resides within the expected peak frequency range, i.e., between the minimum and the maximum of the expected peak frequency of a voice application program, and whether or not the peak power is within the peak power range between the minimum and maximum of the expected peak power of the voice application program. The traffic detection unit 27 judges the packets as the packets of a voice traffic generated by a voice application program based on the results of the examination.

The communication-quality-threshold memory 28 stores therein thresholds based on which the degradation judgement unit 29 detects a degradation in the voice quality. The thresholds define the limit of parameters including statistic values such as dispersion, standard deviation, half-power breadth and peak power of the peak, which determine the shape of the peak and the vicinity thereof in the frequency distribution diagram. The degradation judgement unit 29 examines the voice traffics detected by the traffic detection unit 27, by comparing the parameters of the peak in the frequency distribution diagram calculated by the frequency-distribution calculator 25 against the respective thresholds stored in the communication-quality-threshold memory 22. The degradation detection unit 29 judges occurring of a degradation in the communication quality based on the results of the comparison, and informs the occurring of the communication quality degradation to the notification unit 30. The notification unit 30 displays the occurring of the communication quality degradation as an alarm on a screen of a display unit, for example.

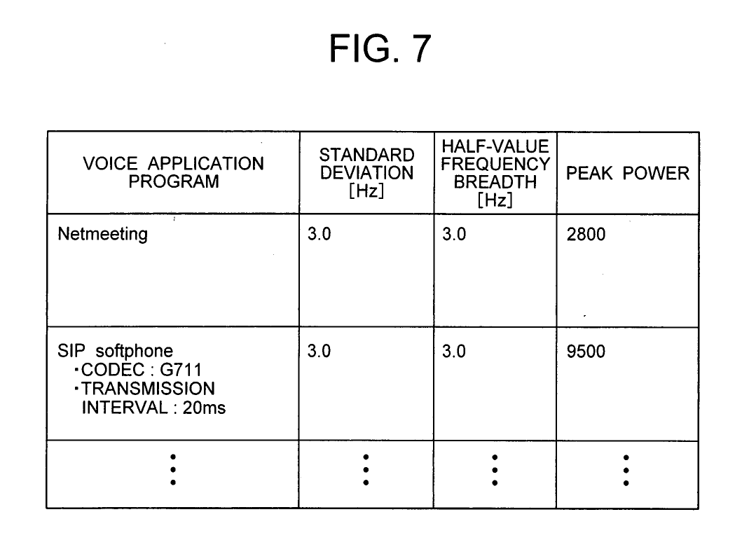

FIG. 7 shows an example of the list of thresholds stored in the communication-quality-threshold memory 28. In this example, the thresholds define the upper or lower limit of parameters including standard deviation, half-width frequency breadth and peak power for each of the voice application programs. The degradation judgement unit 28 refers to the communication-quality-threshold memory 28, and judges occurring of a degradation if the standard deviation and half-power breadth of the frequency distribution diagram calculated exceed the respective parameters, or if the peak power is smaller than the threshold thereof.

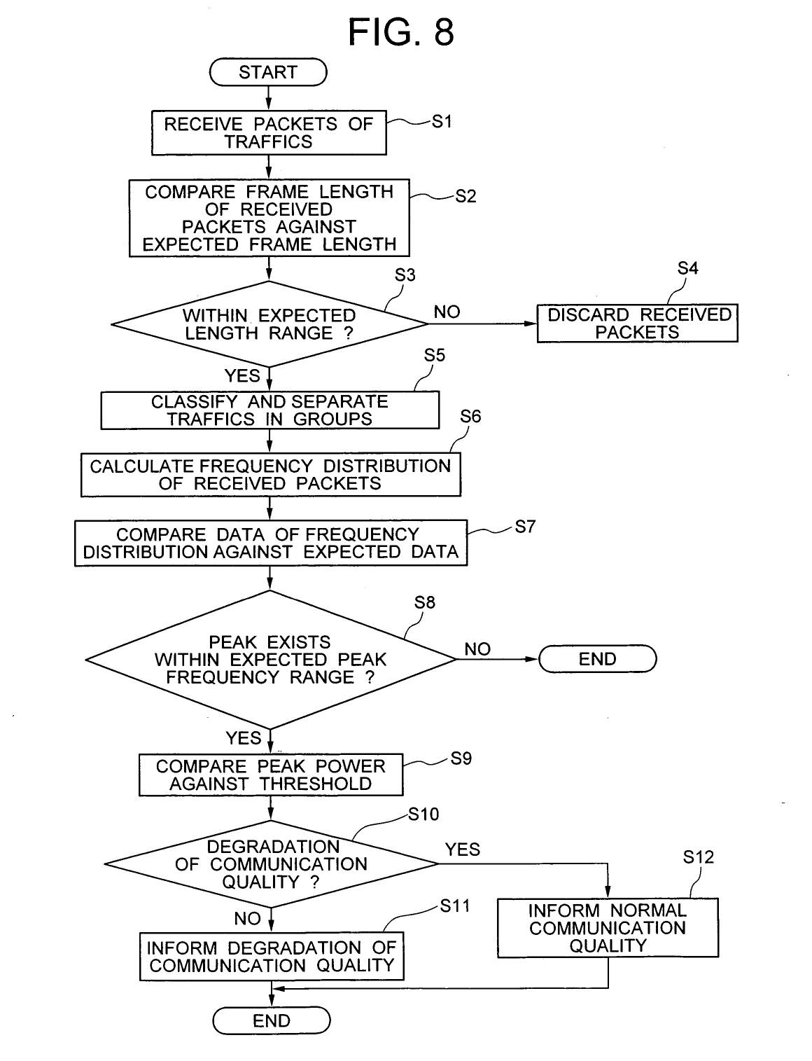

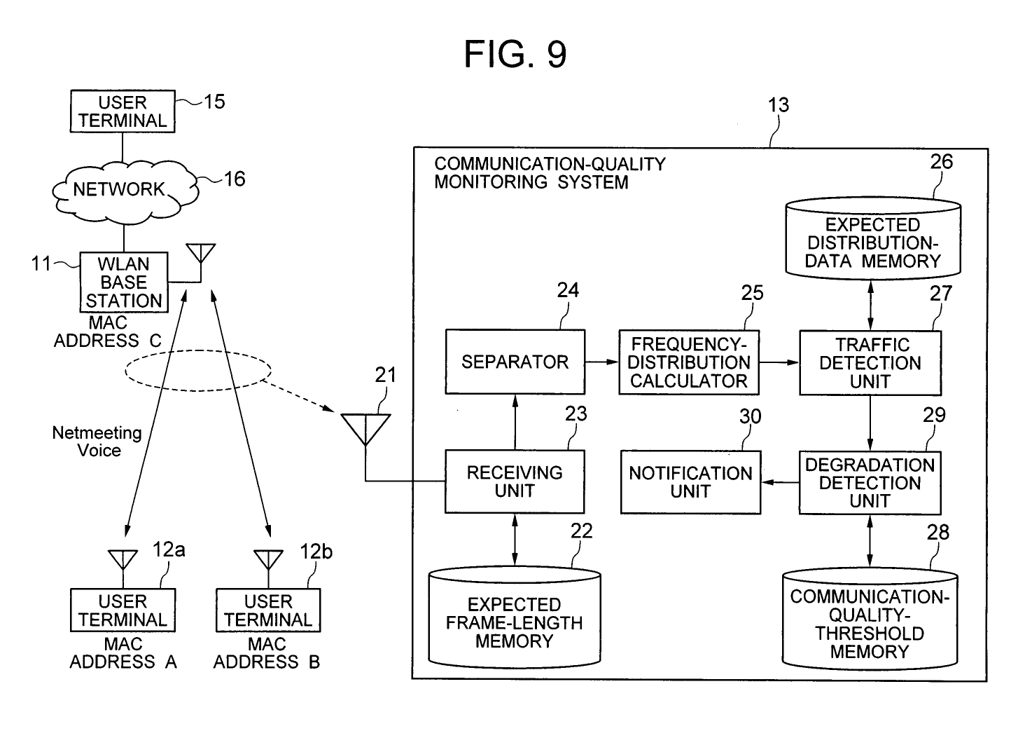

FIG. 8 shows a flowchart of the processings by the communication-quality monitoring system 13 which operates in an exemplified case, as shown in FIG. 19, wherein a user terminal 12a having a MAC address “A” is in communication with another user terminal 15 connected via a network 16 and a WLAN base station 11 having a MAC address “C”. Another user terminal 12b having a MAC address “B” is not operating in a voice communication in FIG. 9.

In FIG. 8, the receiving unit 13 receives packets configuring a traffic between the WLAN base station 11 and the user terminal 12a (step S1). The packets received by the receiving unit 23 are encrypted packets encrypted based on the communication protocol prescribed for the communication between the WLAN base station 11 and the user terminals 12.

The receiving unit 23 compares the frame length of the received packets against the expected frame length stored in the expected frame-length memory 22 (step S2), to judge whether the fame length of the received packets is within the expected frame length range of a voice application program (step S3). The receiving unit 23, if it judges that the frame length of the received packets is not within the expected frame range of any of the voice application programs, determines that the received packets are not voice packets and discards the received packets (step S4).

The receiving unit 23, if it judges that the frame length of the received packets is within the expected frame length range, determines that the received packets possibly configure a voice traffic generated by a voice application program and transfers the received packets to the separator 24. The separator 24 classifies and separates the received packets into a plurality of groups of packets based on the transmission MAC address and the destination MAC address described in a layer-2 header of the received packets (step S5), and transfers the groups of packets to the frequency-distribution calculator25. Before the transfer, the separator 24 may further separates the received packets into sub-groups based on the frame length of the received packets. In this case, the frequency-distribution calculator 25 can calculate the frequency distribution for each communication and each voice application program, thereby reducing noise components in the frequency distribution diagram.

In the example of FIG. 9, if the packets of the user terminal 12a configuring a voice traffic generated by Netmeeting Voice program have a frame length of 78 bites, which coincides with the expected frame length shown in FIG. 2, the received packets are transferred to the separator 24. If the another user terminal 12b operates in transmission of a moving-picture communication at this time, most of the packets of the another user terminal 12b are possibly discarded in step S4 because the packets of the moving picture generally have a frame length longer than the expected frame lengths. However, some of the packets of the user terminal 12b may be transferred to the separator 24 so long as the packets have a frame length coinciding with the expected frame lengths.

The separator 24 classifies and separates the received packets into the groups of packets based on the combination of transmission MAC address and destination MAC address, such as A-to-C, C-to-A, B-to-C, and C-to-B. The packets of the voice traffic transmitted by the user terminal 12a are classified into the combinations A-to-C and C-to-A. If the frame length is used in the sub-group classification, the packets classified into the groups are further classified into sub-groups such as having a frame length of 78 bites, 98 bites, and 214 bites.

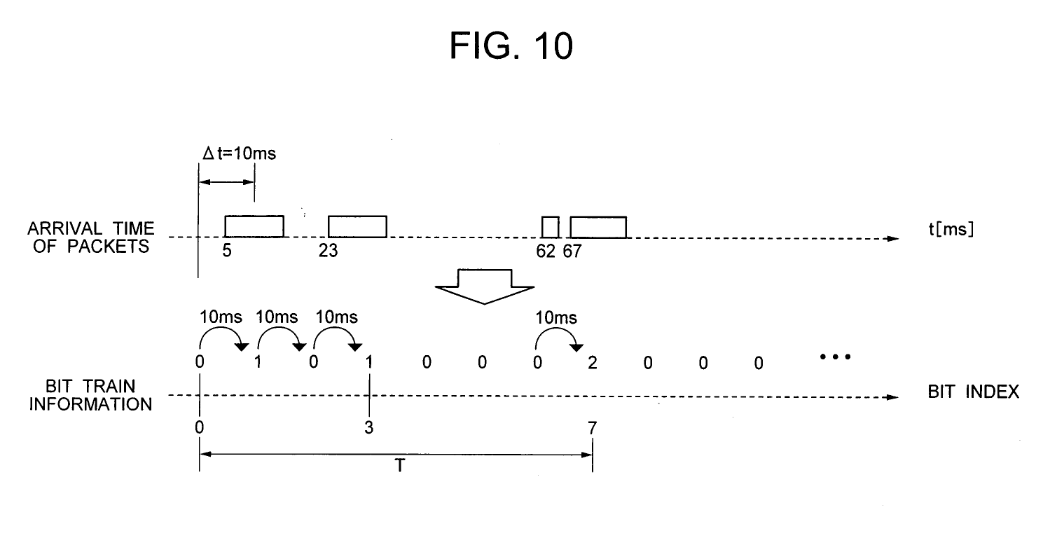

The frequency-distribution calculator 25 calculates the data of frequency distribution diagram of the packets for each groups having respective combinations of transmission MAC address and destination MAC address (step S6). FIG. 10 shows calculation of the distribution of the packets of each group based on the received packets, wherein the top figure shows a timing chart of arrival of individual packets, and the bottom figure shows the counting of number of packets in each unit time interval Δt. The number of arriving packets is counted for each unit time interval Δt=10 ms in the top figure, and a bit “2”, “1” or “0” is generated at each unit time interval Δt to generate a bit train or time-series packet information of a specific time interval T. A Fourie transform is then conducted to the bit train for the specific time interval T to obtain the frequency distribution diagram for each group of packets.

Since the communication generated by the user terminal 12a includes a voice traffic generated by Netmeeting Voice, the step S6 provides a frequency distribution for the packets of transmission terminal 12a (combination of A-to-C and C-to-A), such as shown in FIG. 3 wherein a strong peek or steep peak is observed at a specific frequency.

If the another user terminal 12b operates in a moving-picture communication, the frequency distribution has a noise component corresponding to the moving-picture communication due to some of the packets being counted in the bit stream information. However, since the moving-picture traffic scarcely has a constant interval of transmission, the noise component does not have a strong peak in the frequency distribution diagram.

The traffic detection unit 27 detects a peak from the frequency distribution diagram by using a smoothing differential calculus, calculates the peak frequency and peak power of the detected peak, and compares these parameters against the expected data of the frequency distribution diagram stored in the expected distribution-data memory 26 (step S7). The traffic detection unit 27 judges, based on the comparison, whether or not the frequency distribution diagram includes a peak having a peak power comparable to the expected peak power at the expected peak frequency (step S8).

It is assumed here that the received packets provide the frequency distribution diagram shown in FIG. 3, which has a first peak at around 24 Hz, a second peak at around 33 Hz and a third peak at around 41 Hz. In step S8, comparison of these peaks against the expected data of the frequency distribution diagram of Netmeeting Voice shown in FIG. 6 reveals that the first and third peaks do not reside in the expected peak frequency range, that the second peak resides in the expected peak frequency range, and that the peak power 2940 of the second peak resides in the expected peak power range. Thus, the traffic detection unit 27 judges presence of a subject voice traffic to be detected, due to the second peak having the expected peak range at the expected peak frequency in step S8.

The steps S7 and S8 are performed for each of a plurality of combinations of transmission terminal and destination terminal, if the plurality of combinations are detected. The traffic detection unit 27, if it judges absence of a peak in the expected peak frequency range, determines that the traffic having the combination of transmission terminal and destination terminal is not a voice traffic, and ends the processing.

The traffic detection unit 27, if it judges presence of a peak having the expected peak power at the expected peak frequency, determines that the traffic between the transmission terminal and the destination terminal is a voice traffic, and notifies the presence of the voice traffic to the degradation judgement unit 29. The degradation judgement unit 29 compares the parameters such as dispersion, standard deviation, half-power breadth and peak power of the peak notified from by the traffic detection unit 27 against the respective thresholds stored in the communication-quality-threshold memory 28 (step S9).

The degradation judgement unit 29 judges whether or not a degradation has occurred in the communication quality, based on the results of comparison in step S9 (step S10). In step S10, if the dispersion, standard deviation or half-power breadth of the peak is larger than a corresponding threshold, or if the peak power is smaller than a corresponding threshold, the degradation judgement unit 29 judges that a degradation has occurred in the communication quality. The degradation judgement unit 29, if it judges that a degradation has occurred in step S10, allows the notification unit 30 to display the presence of the degradation and delivers an alarm to the manager of the communication-quality monitoring system (step S11). The degradation judgement unit 29, if it judges that the communication quality is normal in step S10, allows the notification unit 30 to display the absence of a degradation and notifies the manager of a normal communication quality (step S12).

For example, in the case of the frequency distribution diagram shown in FIG. 3, the standard deviation of the frequency distribution diagram is first calculated using a known technique, the calculated standard deviation is compared against the threshold of the standard deviation of Netmeeting Voice stored in the expected distribution-data memory 28. The standard deviation of the frequency distribution diagram shown in FIG. 3 is smaller than the threshold due to the steep peak observed at a frequency of around 33 Hz.

Next, for the second peak having a peak power of 2940 in the frequency distribution diagram, the half-power breadth is calculated and compared against the threshold of the half-power breadth stored in the expected distribution-data memory 28. It is judged that the measured half-power breadth is smaller than the threshold. Next, the peak power 2940 of the second peak is compared against the threshold and judged normal. Thus, the step S10 judges the frequency distribution diagram shown in FIG. 3 as normal in the communication quality.

The method of the present embodiment includes the steps of, as described above, calculating the frame length and frequency distribution of the received traffic, and detecting a peak in the frequency distribution diagram having the expected characteristic of the typical peak of the packets generated by typical voice application programs. Thus, the method provides detection of the voice traffic without the need of protocol analysis of the packets, whereby the method of the present embodiment can detect a voice traffic from the encrypted traffic, such as in a WLAN communication system, where the encryption key is dynamically updated and thus the protocol analysis of the packets is impossible.

The method of the present embodiment allows the communication quality to be judged by observing the dispersion, standard deviation, half-power breadth and peak power of the peak in the frequency distribution diagram of the packets, whereby the communication quality can be judged without using the protocol analysis of the packets.

It is noted that the technique described in JP-2005-57331A detects fluctuation of the arrival time interval of the VoIP packets for evaluation of the voice quality. This necessitates separation of the VoIP packets from the traffic. In the present embodiment, a frequency distribution of the packets is obtained from the time-series information as to the arrival time of the packets, whereby strict separation of the voice packets from the traffic is not essential for evaluation of the communication quality. This is because the voice traffic has a specific peak in the frequency distribution diagram of the packets due to the characteristic of the voice application program, wherein the transmission interval of the voice application program is substantially fixed and can be detected from the frequency distribution.

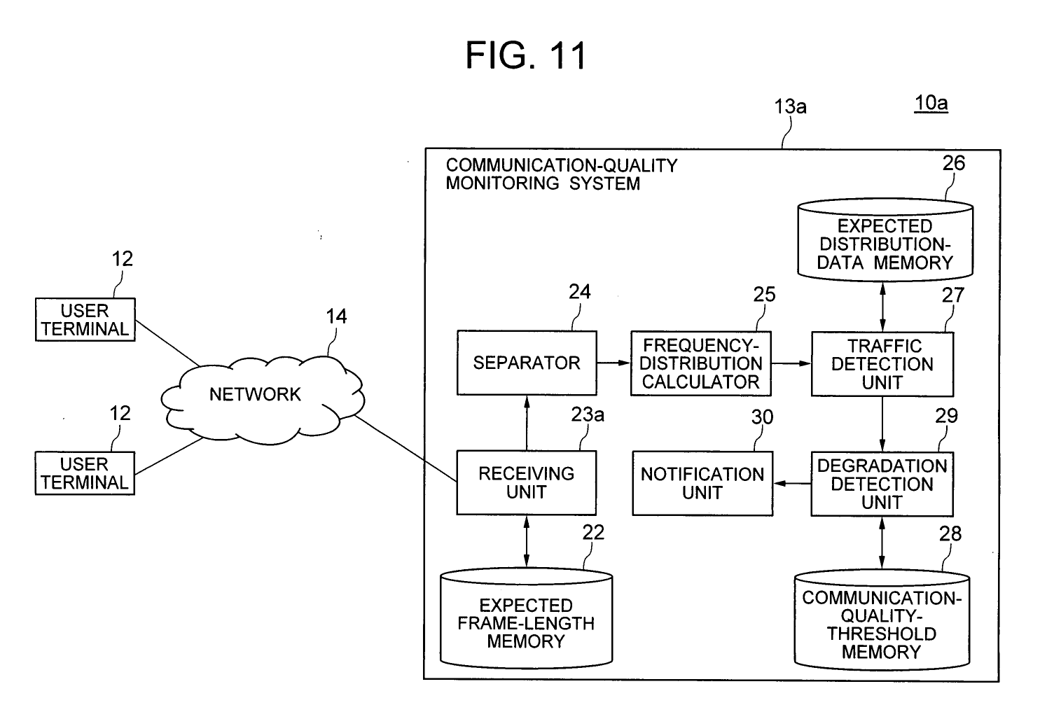

FIG. 11 shows a block diagram of a communication system including a communication-quality monitoring system according to a second embodiment of the present invention. The communication-quality monitoring system 13a shown in FIG. 11 is similar to the communication-quality monitoring system 13 shown in FIG. 1 except that the interface of the receiving unit 23a in the present embodiment is different from that of the first embodiment. The network system 14 in Fig. is a wired network such as the internet.

More specifically, the user terminals 12 are connected to the network 14, on which an encrypted traffic encrypted using an encryption protocol such as IPsec flows. The receiving unit 23a receives the traffic directly from the network 14. The communication-quality monitoring system operates similarly to the first embodiment after reception of the traffic by the receiving unit 23a.

In the present embodiment, expected characteristics such as the expected frame length and expected frequency distribution of the packets are used for detecting the voice traffic from the traffic encrypted using an encryption protocol such as IPsec. The parameters of the frequency distribution diagram of the packets such as dispersion, standard deviation, half-power breadth and peak power are also used for detecting degradation in the communication quality, as in the first embodiment.

It is exemplified that the receiving units 23, 23a in the above embodiments extract the possible voice traffic by using a frame length. However, if the packets are not encrypted, the voice traffic can be extracted by using a packet length or voice frame length in the payload of the packets. In the above embodiments, the separator 24 classifies and separates the packets based on the transmission MAC address and destination MAC address. However, if the packets are not encrypted, the packets may be classified and separated based on other identification data such as IP address, and port number with or without the MAC addresses.

In the above embodiments, the subject traffic to be monitored is a voice traffic and the degradation in the communication quality of the voice traffic is detected for monitoring the communication quality in the network. However, the subject traffic is not limited to the voice traffic. For example, a moving-picture traffic or file transfer traffic generated by other application programs may be monitored. In this case, expected data for the subject traffics are stored in the expected frame-length memory 22 and the expected distribution-data memory 26. In addition, by storing parameters relating to the peak of the frequency distribution diagram in the communication-quality-threshold memory, degradation in the communication quality can be detected.

In the above embodiments, packets having a frame length within the expected frame length range are selected as the subject packets to be calculated for obtaining the frequency distribution diagram. However, all the received packets may be the subject packets to be calculated for obtaining the frequency distribution diagram. In this case, if the user terminal 12a in FIG. 9 uses a moving-picture application program such as Netmeeting Video in addition to the voice application program such as Netmeeting Voice, the frequency distribution diagram of the packets is such that the frequency distribution diagram shown in FIG. 3 and the frequency distribution diagram shown in FIG. 5 are superposed. In this case, since both the application programs have the peak frequencies different from one another, both the peaks can be examined for the peak frequency and peak power independently of each other, whereby the voice traffic can be detected and voice quality can be examined based on the voice traffic. It is to be noted however that a specific traffic which possibly configures a voice traffic is preferable as the subject traffic, because noise can be reduced in the frequency distribution diagram and thus the detection accuracy can be improved.

In the above embodiments, the separator 24 classifies and separates the packets into groups of packets based on the combination of transmission terminal and destination terminal, and each of the groups is used to obtain a distribution diagram. However, the packets need not be necessarily separated into groups. For example, if the user terminal 12a uses a voice application program such as Netmeeting Voice and the user terminal 12b uses a another voice application program such as SIP phone at the same time, the reception unit receives packets generated by both the voice application programs. In this case, the frequency distribution diagram is such that both the frequency distribution diagrams shown in FIGS. 3 and 4 are superposed. In this case, two significant peaks appear at a frequency of around 33 Hz and a frequency of around 50 Hz. Thus, examination of the peak frequency and the peak power of both the peaks provides detection of voice traffics and evaluation of the voice quality based thereon.

Since the above embodiments are described only for examples, the present invention is not limited to the above embodiments and various modifications or alterations can be easily made therefrom by those skilled in the art without departing from the scope of the present invention.

What is claimed is:

1. A traffic detection system comprising:
a receiving unit for receiving packets configuring a traffic on a network;
frequency-distribution calculation unit for calculating a frequency distribution of arrival times of said received packets based on arrival times of said received packets; and
a traffic detection unit for comparing data of said frequency distribution calculated by said frequency-distribution calculation unit against data of an expected frequency distribution of arrival times of a subject traffic to be detected, to detect said subject traffic based on said comparison.

2. The traffic detection system according to claim 1, wherein said traffic on said network includes encrypted packets.

3. The traffic detection system according to claim 1, further comprising a separator for separating said received packets into a plurality of groups of packets based on at least one of a frame length, a transmission terminal and a destination terminal of said received packets, wherein said frequency-distribution calculation unit calculates said frequency distribution for each of said groups.

4. The traffic detection system according to claim 3, wherein said traffic detection unit compares said received packets having a frame length substantially equal to an expected fame length of packets of said subject traffic.

5. The traffic detection system according to claim 3, wherein said separator separates said received packets based on at least one of a MAC address, an IP address and a port number of a transmission terminal and/or a destination terminal of said received packets.

6. The traffic detection system according to claim 1, wherein said data of said expected frequency distribution includes at least one of an expected peak frequency and an expected peak power of an expected peak in said expected frequency distribution.

7. The traffic detection system according to claim 1, wherein said subject traffic is a voice traffic.

8. A traffic detection method comprising the steps of:
receiving packets configuring a traffic on a network;
calculating a frequency distribution of arrival times of said received packets based on arrival times of said received packets; and
comparing data of said frequency distribution calculated by said frequency-distribution calculating step against data of an expected frequency distribution of arrival times of a subject traffic to be detected, to detect said subject traffic based on said comparison.

9. The traffic detection method according to claim 8, wherein said traffic on said network includes encrypted packets.

10. The traffic detection method according to claim 8, further comprising the step of separating said received packets into a plurality of groups of packets based on at least one of a frame length, a transmission terminal and a destination terminal of said received packets, wherein said frequency-distribution calculating step calculates said frequency distribution for each of said groups.

11. The traffic detection method according to claim 10, wherein said comparing step compares said received packets having a frame length substantially equal to an expected fame length of packets of said subject traffic.

12. The traffic detection method according to claim 10, wherein said separating step separates said received packets based on at least one of a MAC address, an IP address and a port number of a transmission terminal and/or a destination terminal of said received packets.

13. The traffic detection method according to claim 8, wherein said data of said expected frequency distribution includes at least one of an expected peak frequency and an expected peak power of an expected peak in said expected frequency distribution.

14. The method according to claim 8, wherein said subject traffic is a voice traffic.

15. A communication-quality monitoring system comprising:
a receiving unit for receiving packets configuring a traffic on a network;
frequency-distribution calculation unit for calculating a frequency distribution of arrival times of said received packets based on arrival times of said received packets; and
a communication quality judgement unit for comparing at lest one parameter of said frequency distribution against a threshold stored in a communication-quality-threshold memory to judge presence or absence of a degradation in a communication quality of said traffic on said network based on said comparison.

16. The communication-quality monitoring system according to claim 1, wherein said traffic on said network includes encrypted packets.

17. The communication-quality monitoring system according to claim 15, wherein said at least one parameter includes at least one of dispersion, standard deviation, half-power breadth and peak power of a peak in said frequency distribution.

18. The communication-quality monitoring system according to claim 17, wherein said communication quality judgement unit judges presence of a degradation if at least one of said dispersion, standard deviation and half-power breadth is larger than a corresponding threshold stored in a threshold memory.

19. The communication-quality monitoring system according to claim 17, wherein said communication quality judgement unit judges presence of a degradation if said peak power is smaller than a corresponding threshold stored in a threshold memory.

20. The communication-quality monitoring system according to claim 15, wherein said traffic on said network is a voice traffic.

21. A communication quality monitoring method comprising the steps of:
receiving packets configuring a traffic on a network;
calculating a frequency distribution of arrival times of said received packets based on arrival times of said received packets;
calculating at least one parameter from said frequency distribution; and
comparing said calculated parameter calculated by said parameter calculating step against a threshold stored in a communication-quality-threshold memory to judge presence or absence of a degradation in a communication quality of said traffic on said network based on said comparison.

22. The communication quality monitoring method according to claim 21, wherein said traffic on said network includes encrypted packets.

23. The communication quality monitoring method according to claim 21, wherein said at least one parameter includes at least one of dispersion, standard deviation, half-power breadth and peak power of a peak in said frequency distribution.

24. The communication quality monitoring method according to claim 17, wherein said communication quality judgement step judges presence of a degradation if at least one of said dispersion, standard deviation and half-power breadth is larger than a corresponding threshold stored in a threshold memory.

25. The communication quality monitoring method according to claim 23, wherein said communication quality judgement step judges presence of a degradation if said peak power is smaller than a corresponding threshold stored in a threshold memory.

26. The communication quality monitoring method according to claim 23, wherein said traffic on said network is a voice traffic.

27. A communication-quality monitoring system comprising:
a receiving unit for receiving packets configuring a traffic on a network;
frequency-distribution calculation unit for calculating a frequency distribution of arrival times of said received packets based on arrival times of said received packets;
a traffic detection unit for comparing data of said frequency distribution calculated by said frequency-distribution calculation unit against data of an expected frequency distribution of arrival times of a subject traffic to be detected, to detect said subject traffic based on said comparison; and
a communication quality judgement unit for comparing at least one parameter of said frequency distribution against a threshold stored in a communication-quality-threshold memory to judge presence or absence of a degradation in a communication quality of said traffic on said network based on said comparison.

28. The communication-quality monitoring system according to claim 27, wherein said traffic on said network includes encrypted packets.

29. The communication-quality monitoring system according to claim 27, further comprising a separator for separating said received packets into a plurality of groups of packets based on at least one of a frame length, a transmission terminal and a destination terminal, wherein said frequency-distribution calculation unit calculates said frequency distribution for each of said groups.

30. The communication-quality monitoring system according to claim 29, wherein said traffic detection unit compares said received packets having a frame length substantially equal to an expected fame length of packets of said subject traffic.

31. The communication-quality monitoring system according to claim 29, wherein said separator separates said received packets based on at least one of a MAC address, an IP address and a port number of a transmission terminal and/or a destination terminal of said received packets.

32. The communication-quality monitoring system according to claim 27 wherein said data of said expected frequency distribution includes at least one of an expected peak frequency and an expected peak power of an expected peak in said expected frequency distribution.

33. The communication-quality monitoring system according to claim 27, wherein said at least one parameter includes at least one of dispersion, standard deviation, half-power breadth and peak power of a peak in said frequency distribution.

34. The communication-quality monitoring system according to claim 33, wherein said communication quality judgement unit judges presence of a degradation if at least one of said dispersion, standard deviation and half-power breadth is larger than a corresponding threshold stored in a threshold memory.

35. The communication-quality monitoring system according to claim 33, wherein said communication quality judgement unit judges presence of a degradation if said peak power is smaller than a corresponding threshold stored in a threshold memory.

36. The communication-quality monitoring system according to claim 27, wherein said traffic on said network is a voice traffic.

37. A communication quality monitoring method comprising the steps of:
receiving packets configuring a traffic on a network;
calculating a frequency distribution of arrival times of said received packets based on arrival times of said received packets;
comparing data of said frequency distribution calculated by said frequency-distribution calculation unit against data of an expected frequency distribution of arrival times of a subject traffic to be detected, to detect said subject traffic based on said comparison,
calculating at least one parameter from said frequency distribution for said detected subject traffic; and
comparing said calculated parameter calculated by said parameter calculating step against a threshold stored in a communication-quality-threshold memory to judge presence or absence of a degradation in a communication quality of said traffic on said network based on said comparison.

38. The communication quality monitoring method according to claim 37, wherein said traffic on said network includes encrypted packets.

39. The communication quality monitoring method according to claim 37, further comprising the step of separating said received packets into a plurality of groups of packets based on at least one of a frame length, a transmission terminal and a destination terminal, wherein said frequency-distribution calculating step calculates said frequency distribution for each of said groups.

40. The communication quality monitoring method according to claim 39, wherein said comparing step compares said received packets having a frame length substantially equal to an expected fame length of packets of said subject traffic.

41. The communication quality monitoring method according to claim 39, wherein said separating step separates said received packets based on at least one of a MAC address, an IP address and a port number of a transmission terminal and/or a destination terminal of said received packets.

42. The communication quality monitoring method according to claim 37 wherein said data of said expected frequency distribution includes at least one of an expected peak frequency and an expected peak power of an expected peak in said expected frequency distribution.

43. The communication quality monitoring method according to claim 37, wherein said at least one parameter includes at least one of dispersion, standard deviation, half-power breadth and peak power of a peak in said frequency distribution.

44. The communication quality monitoring method according to claim 43, wherein said communication quality judging step judges presence of a degradation if at least one of said dispersion, standard deviation and half-power breadth is larger than a corresponding threshold stored in a threshold memory.

45. The communication quality monitoring method according to claim 43, wherein said communication quality judging step judges presence of a degradation if said peak power is smaller than a corresponding threshold stored in a threshold memory.

46. The communication quality monitoring method according to claim 37, wherein said traffic on said network is a voice traffic.

47. A program running on a computer to operate said computer in the processings of:
receiving packets configuring a traffic on a network;
calculating a frequency distribution of arrival times of said received packets based on arrival times of said received packets; and
comparing data of said frequency distribution calculated by said frequency-distribution calculation unit against data of an expected frequency distribution of arrival times of a subject traffic to be detected, to detect said subject traffic based on said comparison.

48. A program running on a computer to operate said computer in the processings of:
receiving packets configuring a traffic on a network;
calculating a frequency distribution of arrival times of said received packets based on arrival times of said received packets;
calculating at least one parameter from said frequency distribution; and
comparing said calculated parameter calculated by said parameter calculating processing against a threshold stored in a communication-quality-threshold memory to judge presence or absence of a degradation in a communication quality of said traffic on said network based on said comparison.

49. A program running on a computer to operate said computer in the processings of:
receiving packets configuring a traffic on a network;
calculating a frequency distribution of arrival times of said received packets based on arrival times of said received packets;
comparing data of said frequency distribution calculated by said frequency-distribution calculation unit against data of an expected frequency distribution of arrival times of a subject traffic to be detected, to detect said subject traffic based on said comparison;
calculating at least one parameter from said frequency distribution for said detected subject traffic; and
comparing said calculated parameter calculated by said parameter calculating processing against a threshold stored in a communication-quality-threshold memory to judge presence or absence of a degradation in a communication quality of said traffic on said network based on said comparison.
